(19) United States
(12) Patent Application Publication
(10) Pub. No.: US 2011/0248093 A1
(43) Pub. Date: Oct. 13, 2011

(54) IRRIGATION SPRINKLER NOZZLE HAVING DEFLECTOR WITH MICRO-RAMPS

(76) Inventor: Eugene Ezekiel Kim, Buena Park, CA (US)

(21) Appl. No.: 12/757,912

(22) Filed: Apr. 9, 2010

(51) Int. Cl. B05B 1/26

(52) U.S. Cl. 239/11; 239/523

(57) ABSTRACT

A spray nozzle for an irrigation sprinkler is provided, where the nozzle has a deflector that is configured with depending ribs. Each of the ribs has micro-structures that cooperate with other geometry of the rib and deflector to define a plurality of different micro-ramps for dividing the discharged water into different sprays having different characteristics that can be combined to achieve a spray pattern.

### FIELD

This disclosure relates generally to an irrigation sprinkler nozzle and, in particular, to an irrigation sprinkler nozzle having a deflector.

### BACKGROUND

Efficient irrigation is a design objective of many different types of irrigation devices, such as gear-drive rotors, rotary spray nozzles, and fixed spray nozzles. That objective has been heightening due to concerns at the federal, state and local levels of government regarding the efficient usage of water. Over time, irrigation devices have become more efficient at using water in response to these concerns. However, those concerns are ongoing as demand for water increases.

As typical irrigation sprinkler devices project streams or sprays of water from a central location, there is inherently a variance in the amount of water that is projected to areas around the location of the device. For example, there may be a greater amount of water deposited further from the device than closer to the device. This can be disadvantageous because it means that some of the area to be watered will be over watered and some of the area to be watered will receive the desired about of water or, conversely, some of the area to be watered will receive the desired amount of water and some will receive less than the desired about of water. In other words, the distribution of water from a single device is often not uniform.

One measure of how uniformly water is applied to an area being watered is called Distribution Uniformity “DU”, which is expressed as a percentage. One common measure of Distribution Uniformity is the Lower Quarter Distribution Uniformity (“DU_{lq}”), which is a measure of the average of the lowest quarter of samples, divided by the average of all samples:

$${DU}_{lq} = \frac{Average Catch of Lower Quarter \times 100}{Average Catch Overall}$$

For example, if all samples are equal, the DU is 100%. If a proportion of the area greater than 25% receives zero application the DU will be 0%. DU can be used to determine the total watering requirement during irrigation scheduling. For example, one may want to apply not less than one inch of water to the area being watered. If the DU were 75%, then the total amount to be applied would be the desired about of water (one inch) divided by the DU (75%), or 1.33 inches of water would be required so that only a very small area receives less than one inch of water. The lower the DU, the less efficient the distribution and the more water that must be applied to meet the minimum desired. This can result in undesirable over watering in one area in order to ensure that another area receives the minimum water desired.

Another measurement is called the Scheduling Coefficient (“SC”). Unlike the DU, the scheduling coefficient does not measure average uniformity. Instead, it is a direct indication of the dryness of the driest turf areas (critical areas). The measurement is called the Scheduling Coefficient because it can play a role in establishing irrigation times. It is based on the critical area to be watered. To calculate the SC, one first identifies the critical area in the water application pattern which is receiving the least amount of water. The amount of water applied to this critical area is divided into the average amount of water applied throughout the irrigated area to obtain the Schedule Coefficient. The scheduling coefficient indicates the amount of extra watering needed to adequately irrigate the critical area. If perfect uniformity were obtained, the scheduling coefficient would be 1.0 (no extra watering needed to adequately irrigate the critical area). By way of example, assume that an irrigation pattern has a scheduling coefficient of 1.8. After 15 minutes of irrigation, a critical area would still be under-watered due to non-uniformity. It will take an additional 12 minutes (15 minutes×1.8) to apply an adequate amount of water to the critical area (or 27 minutes total). While that is the amount of time needed to water the critical area, the result is that other areas will be over-watered.

There are many applications where conventional spray nozzle irrigation devices are desirable for use. Unfortunately, conventional spray nozzle irrigation devices can undesirably have lower DU_{lq} values. For example, some conventional fixed spray devices can have DU_{lq} values of about 65% and be considered to have a very good rating, DU_{lq} values of about 70% for rotors are considered to have a very good rating.

### SUMMARY

Spray nozzles having either an arcuately fixed or adjustable spray patterns are described herein, wherein the nozzles have deflectors that are configured with depending ribs having micro-structures that cooperate with other geometry of the rib and deflector to define a plurality of different micro-ramps for dividing the discharged water into different sprays having different characteristics. The different sprays with the different characteristics combine to provide for an improved spray pattern. The result is that advantageously higher DU_{lq} and lower SC values can be achieved, including in a variable arc nozzle.

Water is discharged through one or more flow openings upstream of the deflector in a direction that is generally parallel a central axis of the nozzle (or at an angle from perpendicular thereto). When the discharged water hits an inclined portion of the deflector, the deflector redirects the water outwardly, with the ribs generally confining the water to being radially outwardly. However, the momentum of the water reacts to the impact with the deflector by wanting to move outwardly against the bottom of channels formed between adjacent pairs of the ribs as well against the sidewalls of the ribs. Essentially, the behavior of the water upon impact with the deflector is such that a significant fraction wants to remain close to the structure as opposed to completely filling the channels. In other words, a large fraction of the water tends to “ride along” the sides of the ribs and the bottom of the channels. In order to take advantage of this behavior of the discharged water, very minute structural variances in the portions of the deflector that the water comes into contact with can have a significant impact on the water passing thereagainst. That is, making non-uniform ribs, such as with steps or other protuberances or variations, can provide micro-ramps for altering the flow pattern of the water thereagainst as compared to adjacent water flows. In this manner, the discharging flow of water can be segregated by the deflector into different sprays having different characteristics which can be tailored to achieve certain objectives, such as sprays that are intended to irrigate different areas which, when combined, can result in a more efficient irrigation spray pattern.

In one aspect, a spray nozzle is provided having a deflector body downstream of a flow opening to deflect water discharge from the flow opening. The deflector body has a plurality of depending ribs forming channels for water flow therebetween, and a plurality of the ribs each have an outwardly-extending step at least partially along the length of the ribs such that a micro-ramp extends into the channels for directing a portion of the water flow.

In another aspect, a spray nozzle is provided having a base having a longitudinal axis and at least one water passage extending through base. A deflector body has an upper deflector portion and a lower neck and is fixed relative to the base. The deflector body has a plurality of radially-outward extending, depending ribs forming channels for water flow therebetween, where the ribs each having a pair of sidewalls and a bottom wall with the sidewalls each having a primary micro-ramp projecting laterally a first distance from the sidewall and spaced from a bottom of the channel to define a primary path for water flow outwardly from the nozzle.

In either of the foregoing aspects, the spray nozzle may be of a fixed-arc type or a variable arc-type. In the case of a variable arc-type spray nozzle, a first nozzle body may be provided having a first helical surface. A second nozzle body can be rotatably associated with the first nozzle body and can include a second helical surface. The first and second helical surfaces are configured to cooperate to define an arcuate flow opening adjustable in size to determine an arc of water distribution upon rotation of the first nozzle body relative to the second nozzle body. In one example, the second nozzle body can be in the form of a collar and the first nozzle body can include a deflector that are mounted for relative rotation. The collar has a collar helical surface configured to cooperate with a deflector helical surface of the deflector to define an arcuate flow opening, upstream of an upper deflector portion, that is adjustable in size to determine an arc of water distribution upon rotation of the collar relative to the deflector.

A method is also provided for distributing water from the spray nozzle which includes the step of deflecting at least some of the water radially outward along a plurality of flow paths disposed between adjacent pairs of the ribs and the bottom of the channels, a first of the flow paths on a side of the steps closer to the bottom wall having a first fraction of the total discharged water volume and a second of the flow paths on a side of the step opposite the bottom wall having a second fraction of the total discharged water volume, the second fraction being different than the first fraction.

In any of the foregoing aspects, the deflector body may optionally have an upper portion with an underside with the depending ribs thereon and a lower portion with a neck depending from the underside with a plurality of flow notches disposed about its outer periphery. The flow notches may be aligned with channels formed between the ribs such that a water flow path extends through the flow notches into the channels.

### BRIEF DESCRIPTION OF THE DRAWINGS

FIG. 1 is an exploded perspective view of an exemplary embodiment of a variable arc irrigation nozzle, depicting a deflector, a collar, a base and an adjustment screw, where the deflector includes a plurality of radially-extending ribs forming channels for water flow therebetween, the ribs having micro-ramps configured for providing different aspects of the spray pattern;

FIG. 2 is a perspective view of the variable arc irrigation nozzle of FIG. 1 in an assembled configuration;

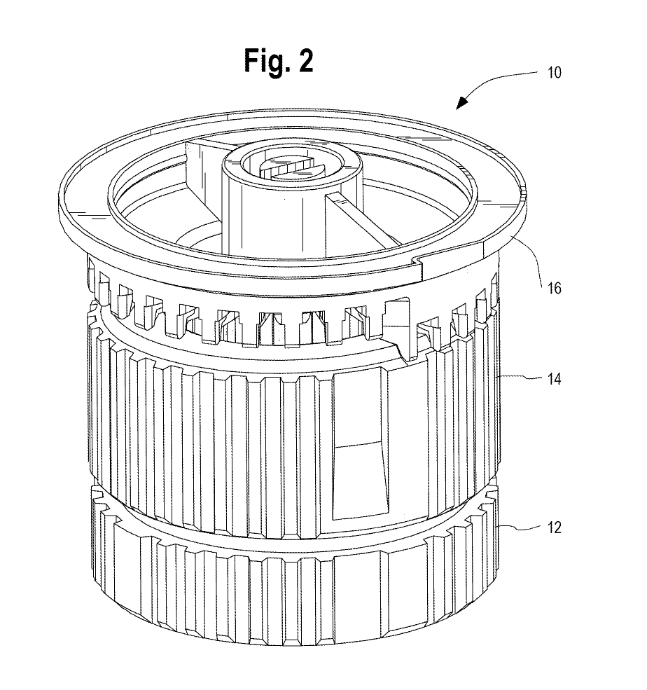

FIG. 3 is a top plan view of the assembled variable arc irrigation nozzle of FIG. 1;

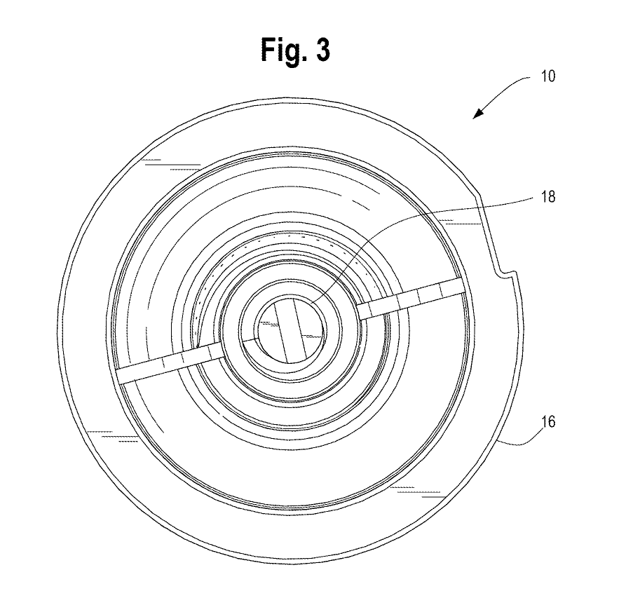

FIG. 4 is a cross-section view of the assembled variable arc irrigation nozzle taken along line IV-IV of FIG. 3;

FIG. 5 is a cross-section view of the assembled variable arc irrigation nozzle similar to FIG. 4, but showing diagrammatic flow paths discharging from the nozzle;

FIG. 6 is a top plan view of the base of the variable arc irrigation nozzle of FIG. 1;

FIG. 7 is a perspective view of the collar of the variable arc irrigation nozzle of FIG. 1;

FIG. 8 is a perspective view of the underside of the deflector of the variable arc irrigation nozzle of FIG. 1;

FIG. 9 is a detailed perspective view of some of the ribs on the underside of the deflector of the variable arc irrigation nozzle of FIG. 1;

FIG. 10 is a detailed bottom plan view of a portion of the underside of the deflector of the variable arc irrigation nozzle of FIG. 1;

FIG. 11 is a perspective view of a section of the deflector of the variable arc irrigation nozzle of FIG. 1 showing details of the ribs;

FIG. 12 is a side elevation view of the deflector of the variable arc irrigation nozzle of FIG. 1;

FIG. 13 is an image based upon CFD analysis of water flow along the ribs of the variable arc irrigation nozzle of FIG. 1; and

FIG. 14 is a schematic diagram depicting an idealized flow discharging from the variable arc irrigation nozzle of FIG. 1.

### DETAILED DESCRIPTION

As shown in the exemplary drawings, a new and improved sprinkler spray nozzle for use in irrigation is provided. The spray nozzle has a deflector that provides for the separation of discharging water into different sprays in order to improve the overall spray pattern and, in particular, the DU_{lq} and SC values associated with the spray nozzle. Unlike conventional spray nozzles, which often have deflectors with simple, radially-extending vanes, the deflector of the exemplary embodiment has a deflector with depending ribs, where the ribs in turn each have one or more micro-ramps or other structures protruding into the flow paths of the water which guide the deflected water flow in different sprays which can have different characteristics. The different sprays with the different characteristics combine to provide for an improved spray pattern. Moreover, the spray pattern can be tailored by adjusting the geometries of the micro-ramps and the ribs depending upon the desired application or irrigation spray pattern. In one aspect, the deflector can receive discharging water from an arcuately-adjustable opening such that the arc of the spray pattern can be adjusted. However, the deflector described herein and, in particular, the division of the deflected fluid, can also be incorporated into a fixed spray-type sprinkler nozzle or a rotary-type sprinkler nozzle.

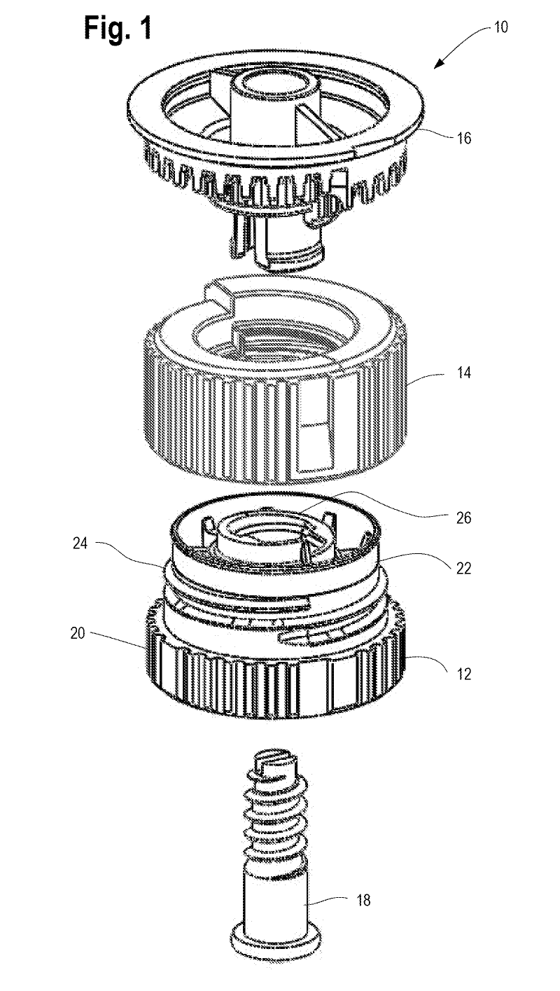

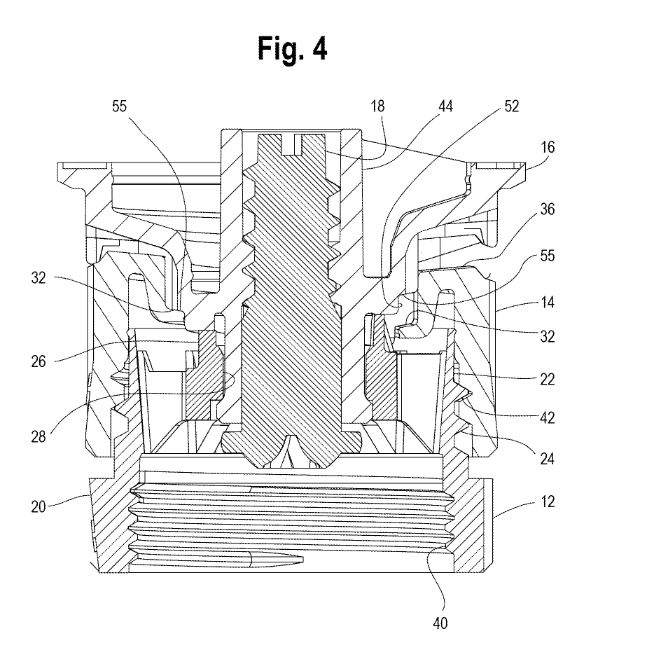

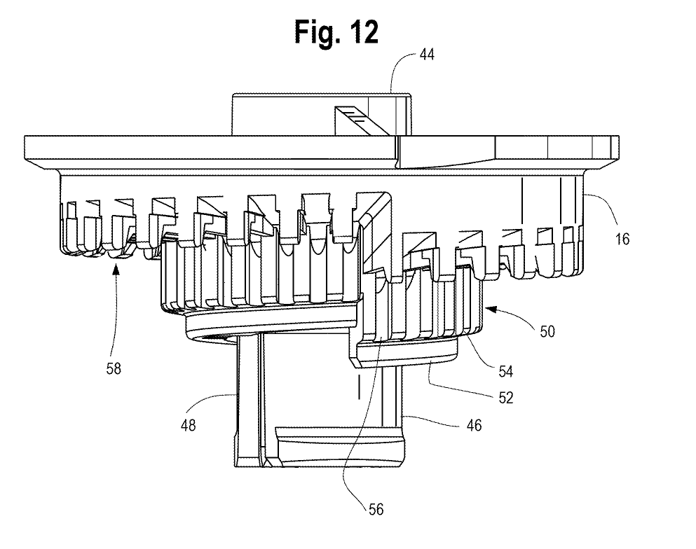

In an exemplary embodiment, a spray nozzle 10 for an irrigation device includes a base 12, a collar 14, a deflector 16 and a screw 18, as illustrated in FIG. 1. The base 12 includes a lower skirt 20 and an upper skirt 22, both surrounding a central opening. The lower skirt 20 includes internal threads 40 (illustrated in FIG. 4) to allow the base 12 (and hence the assembled nozzle 10) to be threadingly connected to a riser, stand or the like of a sprinkler for receiving pressurized water. The upper skirt includes external threading 24 configured to mate with internal threading 42 of the collar 14, as shown in FIG. 4. The collar 14 can be rotated relative to the base 12 along the mating threads 24 and 42 such that the collar 14 can rotate about the base 12. The deflector 16 includes an upper deflector surface 58 with a depending neck 50, as illustrated in FIG. 12. The deflector surface 58 is disposed on an opposite side of the collar 14 from the base 12, and the neck 50 of the deflector 16 extends through the collar 14 and partially into the central opening of the base 12, as depicted in FIG. 4. The depending neck 50 of the deflector 16 is adapted to be attached to the base 12, as will be described in greater detail herein, such that the deflector 16 is not rotatable relative to the base 12. The screw 18 may be an adjustable flow rate adjustment screw to regulate water flow through the nozzle 10.

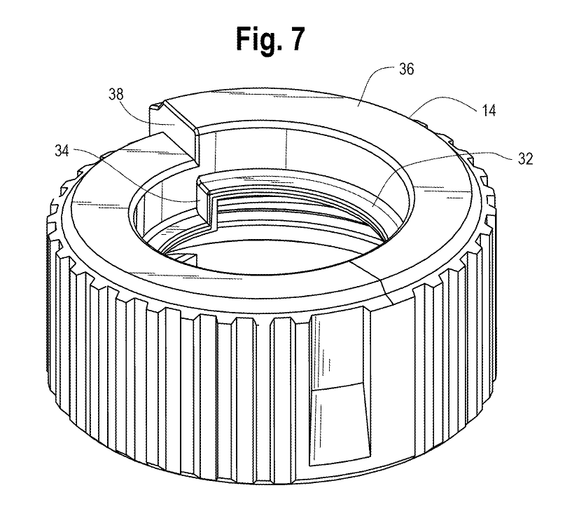

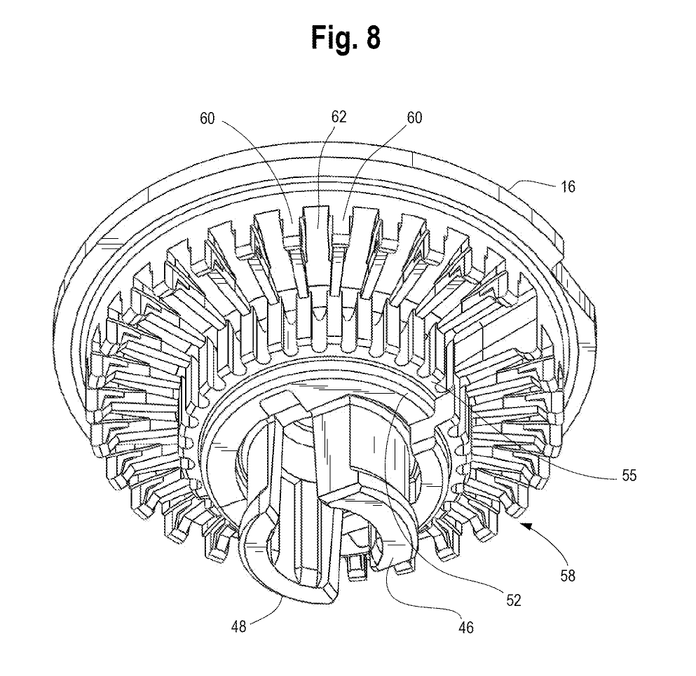

The illustrated embodiment of the nozzle 10 includes variable arc capability such that the arcuate extent of the spray pattern emanating from the nozzle 10 can be adjusted. The collar 14 includes a radially-inward extending helical ledge 32, as illustrated in FIG. 7. Ends of the ledge 32 are axially spaced and are connected by an axially-extending wall 34. The ledge 32 has an upwardly-facing surface and a radially-inward edge surface. An upper face 36 of the collar 14 is also helical, having the same pitch as the ledge 32 and with ends thereof joined by an axially extending face wall 38, also as illustrated in FIG. 7. The neck 50 of the deflector 16 includes a downward-facing helical surface 55 and a depending, radially-outward facing helical wall 52, as illustrated in FIG. 8, both of which have the same pitch as the ledge 32 of the collar 14. The downward-facing helical surface 55 of the deflector 16 lies over the ledge 32 of the collar 14.

As the collar 14 is rotated relative to the deflector 16, however, the radially-inward edge surface of ledge 32 of the collar 14 is brought into or out of sliding and sealing engagement with the helical wall 52 of the deflector 16 in order to increase or decrease the arcuate extent of a water discharge opening. In a fully closed position, the radially-inward edge surface of the ledge 32 of the collar and the helical wall 52 of the deflector 16 are sealingly engaged to block water flow through the spray nozzle. Rotation of the collar 14 then increase the axially spacing between the edge surface of the ledge 32 of the collar and the helical wall 52 of the deflector 16 such that they have overlying segments that are not sealingly engaged through which the water discharge opening is defined. In this manner, the arcuate extent of the water discharge opening, and thereby the arcuate extent of the spray, can be readily adjusted. By way of example, the collar 14 in FIG. 4 has been rotated to a position whereby the water discharge opening is about 180-degrees. As can be seen on the left side of FIG. 4, the edge surface of the ledge 32 of the collar 14 is sealingly engaged with the helical wall 52 of the deflector 16 but on the right side they are axially spaced.

Turning now to details of the upper deflector surface 58 of the deflector 16, a plurality of radially-extending ribs 60 depend from the underside, as illustrated in FIGS. 8-11. Discharge channels for water are formed between adjacent ribs and have bottoms 62 coinciding with the underside of the upper deflector surface 58. The ribs 60 are each configured to divide the water flow through the channels into different sprays directed to different areas and thereby having different characteristics. The different sprays with the different characteristics are combined to provide for an improved spray pattern having improved DU_{lq} and SC values as compared to conventional spray nozzles, including conventional spray nozzles configured for variable arc adjustment, as will be discussed in greater detail herein.

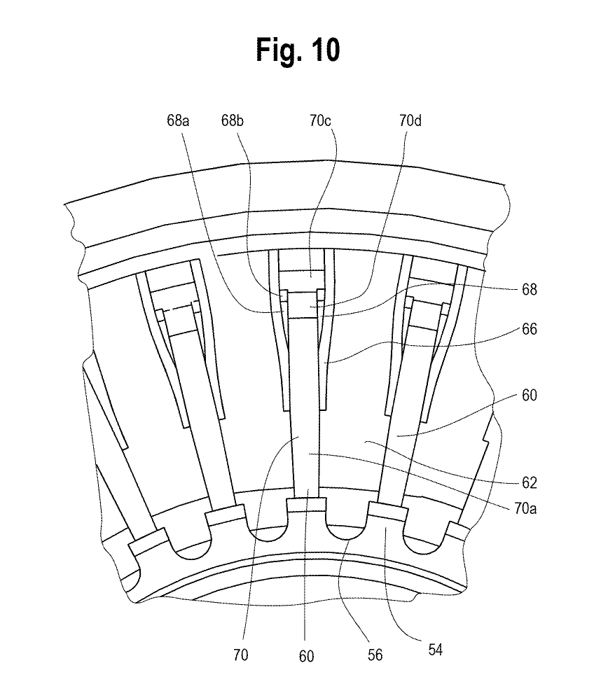

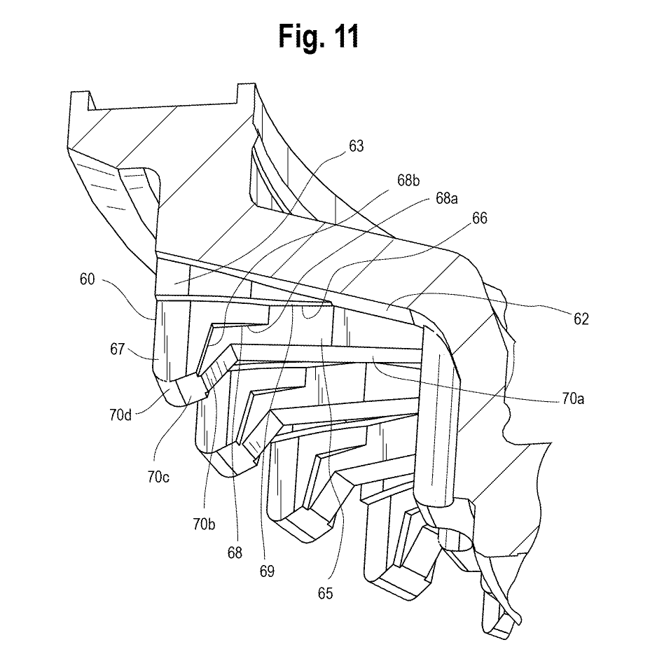

Each of the ribs 60 has an inner end adjacent the neck 50, and outer end radially outward from the neck 50, a pair of sidewalls and a bottom wall 70. As the ribs 60 are each generally symmetric about a radially-extending line, only one of the sides of a representative rib 60 will be described with it being understood that the opposite side of that same rib 60 has the same structure. With reference to FIGS. 10 and 11, the rib 60 has a first step 66 forming in part a first micro-ramp and a second step 68 defining in part a second micro-ramp. The first step 66 is generally linear and positioned at an angle closer to perpendicular relative to a central axis of the deflector as compared to the bottom 62 of the upper deflector surface 58, as shown in FIG. 11. The second step 68 is segmented, having an inner portion 68a that extends closer to perpendicular relative to the central axis as compared to an outer portion 68b, which has a sharp downward angle.

The first and second steps 66 and 68 divide the sidewall into three portions having different thicknesses: a first sidewall portion 63 disposed adjacent an outward region of the bottom 62 of the upper deflector surface 58; a second, narrower sidewall portion 67 disposed partially on an opposite side of the first step 66 from the first sidewall portion 63; and a third, yet narrower sidewall portion 65 having an outer region disposed on an opposite side of the second step 68 from the first step 66, a middle region disposed on an opposite side of the first step 66 from the bottom 62 of the upper deflector surface 58, and an inner region disposed adjacent the bottom 62, as depicted in FIG. 11. The outer portion 68b of the second step 68 is spaced inwardly from the outer end of the rib 60 by a second sidewall portion 67. An inclined sidewall segment 69 is disposed radially inward from the second sidewall portion 67.

The underside or bottom wall 70 of the rib 60 has a first, generally linear segment 70a positioned at an angle closer to perpendicular relative to a central axis of the deflector 16 as compared to an inner, inclined intermediate segment 70b and the bottom 62 of the upper deflector surface 58, as shown in FIG. 11. An outer, inclined intermediate segment 70c is closer to perpendicular than the inner intermediate segment 70b but not as close to perpendicular as the first segment 70a. An upwardly curved segment 70d is disposed at the end of the rib 60.

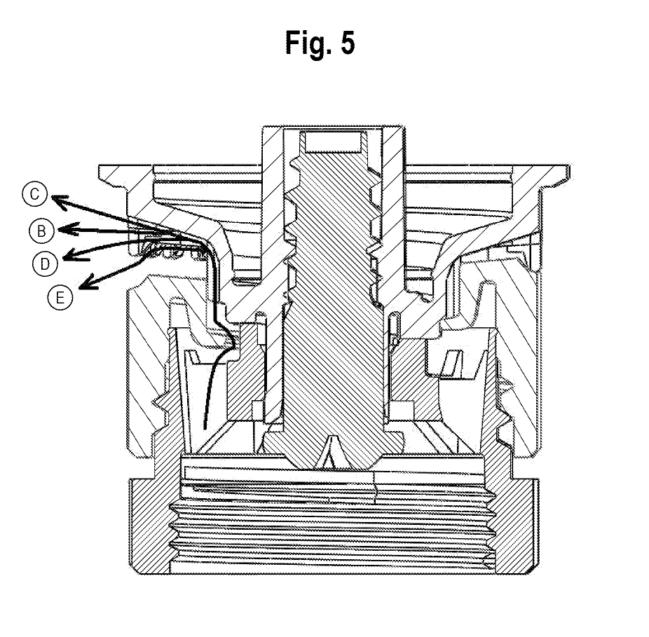

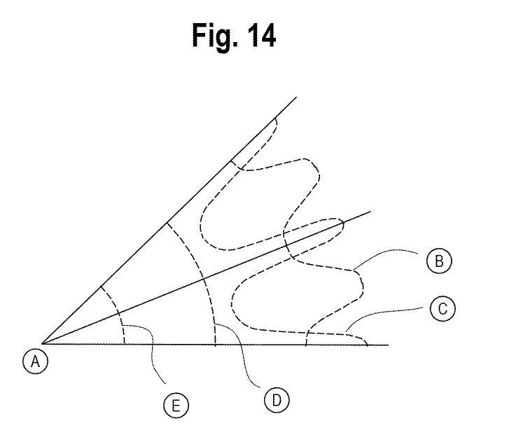

The geometries of the ribs 60 and the bottom 62 of the of the upper deflector surface 58 cooperate to define a plurality of micro-ramps which divide the discharging water into sprays having differing characteristics. More specifically, and with reference to FIGS. 5 and 14, there is a first spray B, a second spray C, a mid-range spray D and a close-in spray E as measured from the location A of the spray nozzle 10. The first and second sprays B and C may combine or may be coextensive to form a primary spray. The first and second sprays B and C can have the furthest throw, but may be angularly offset from each other to minimize gaps between the sprays. The mid-range spray D and the close-in spray E are progressively closer to the location A of the spray nozzle 10, as depicted in FIG. 14. When the different sprays are combined, the result is a spray pattern which provides for improved DU_{lq} and SC values as compared to conventional arcuately adjustable, fixed spray nozzles.

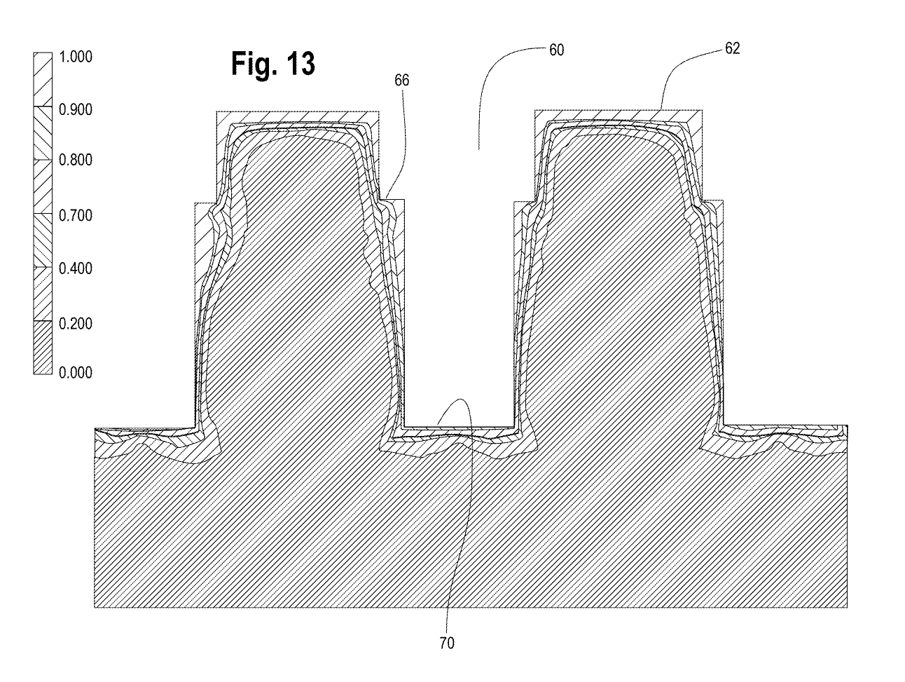

The micro-ramp associated with the first spray B is defined by the first step 66 and the adjacent portions of the sidewall of the rib 60, such as portion of sidewall segment 65, 69 and 67, with reference to FIG. 11. The micro-ramp associated with the second spray C is defined by the bottom 62 of the upper deflector surface 58 and the adjacent portions of the sidewall of the rib 60, such as segment 63, also with reference to FIG. 11. As can be seen from the image of FIG. 13 from the CFD analysis of the water flow, the vast majority of the water tends to flow immediately adjacent the ribs 60 and the bottom 62 of the channels and opposed to evenly filling the space between the ribs 60. Accordingly, the position of the first step 66 relative to the bottom 62 can be selected to vary the amount or fraction of the water flowing along the first micro-ramp as opposed to the second micro-ramp. For example, moving the first step 66 closer to the bottom 62 will increase the depth of the first micro-ramp and thereby increase its fraction of water as compared to the second micro-ramp. As shown in this example, there is a greater fraction of the water flow in the first micro-ramp as compared to the second micro-ramp.

In order to provide for the phase shifting of the spray from the first micro-ramp relative to the spray from the second micro-ramp, the outward ends 67 of the sidewalls of the ribs 60 narrow or taper toward each other, such that a pair of sub-sprays each flowing along the primary micro-ramp on opposite sides of the same rib 60 combine to form a common primary spray. This angularly shifts the first spray from being directly radially outward in the direction of the bottom 62 of the channels.

The micro-ramp associated with the mid-range spray D is defined by second step 68 and those portions of the sidewall of the rib 60 on an opposite thereof from the first step 66, such as a portion of sidewall segments 65. The sharply inclined end segment 68b is configured to direct the water spray more downwardly as compared to the spray from the first micro-ramp. Finally, the micro-ramp associated with the close-in spray E is defined by the underside 70 of the rib 60, including the downturned end segments 70b and 70c, for directing the water flow a shorter throw as compared to the mid-range spray D, the second spray C and the first spray B. It will be understood that the geometries, angles and extend of the micro-ramps can be altered to tailor the resultant combined spray pattern. Further, while it is presently believed to be preferable to have all or nearly all (at least about 80%, 85%, 90%, or 95%) of the ribs 60 with the micro-ramps, it is foreseeable that in some circumstances it may be preferable to have less than all of the ribs include micro-ramps. For instance, the micro-ramps may be on only one side of each of the ribs, may be in alternating patterns, or the like.

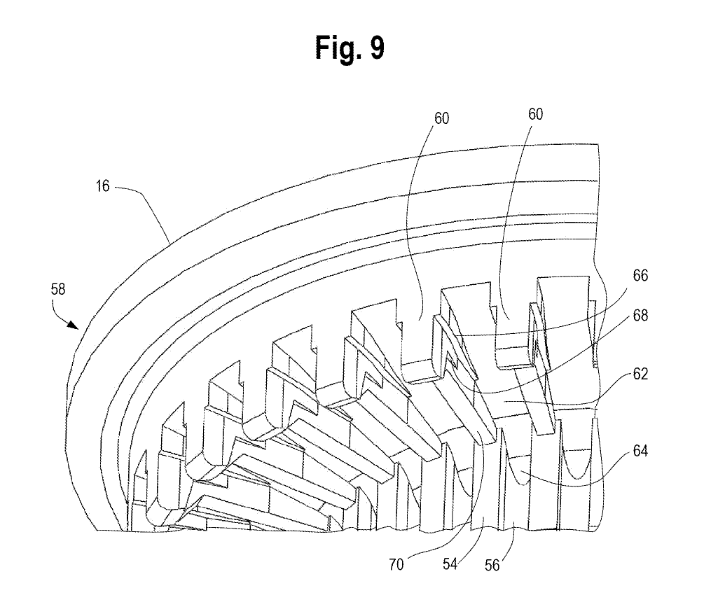

Extending about the outer circumference of a portion of the neck 50 of the deflector 16 are a plurality of radially-projecting and axially-extending ribs 54 which are spaced by axially-extending flow notches 56. The flow notches 56 have an upstream entrance disposed radially outward from the downwardly-facing helical wall 55, as illustrated in FIG. 8. A downstream exit of the flow notches 56 is aligned with the channels between adjacent ribs 60, as illustrated in FIG. 9. An inclined ramp 64 at the intersection of each of the channels and the flow notches 56 can assist in gradually turning the flow from being generally axially to projecting generally radially outwardly. The flow notches 56 can improve the ability of the spray nozzle 10 to provide for a matched precipitation rate, particularly desirable given the adjustable nature of the arcuate extent of the spray pattern from the spray nozzle 10. In other words, the flow notches 56 contribute to having proportional volumes of water discharged for given arcuate spray pattern settings.

In the exemplary embodiment of a variable arc spray nozzle 10 depicted in the accompanying figures, the nozzle 10 may be configured to have a 12′ throw. There may be thirty flow notches 56 feeding thirty channels separated by ribs 60, with thirty ribs 60 total and one rib extending from the ends of the helically-inclined array of ribs 60, which one rib lacks micro-ramps in the illustrated embodiment. Each of the axially-extending ribs projects outwardly about 0.0255 inches, has a width at its outward end of about 0.024 inches and adjacent ones form a flow notch 56 with an inward taper of about 6.2 degrees with a bottom radius of about 0.0125 inches. The length may be about 0.92 inches. The inclined ramp 64 may be outwardly-inclined at about 20 degrees relative to a central axis. The ribs 60 are spaced at about 10 degrees to about 12 degrees apart. The first step 66 is between about 0.004 and 0.008 inches in width from the sidewall of the adjacent portion of the rib 60, such as about 0.006 inches. A distal end of each of the ribs 60, including the first step 66, may be about 0.040 inches with about a 3 degree taper, with the portion on the opposite side of the step 66 from the bottom wall 62 being about 0.028 inches in width, with a proximate end of each of the ribs 60 being about 0.018 inches. The second step 68 may be between about 0.002 and 0.006 inches in width, such as about 0.004 inches in width. The angle of the linear portion 70a of the bottom wall 62 may be about 9 degrees toward a horizontal plane coinciding with the top of the deflector 16, with the inward segment 70b being inclined about 50 degrees away from the plane and the intermediate segment 70c being inclined about 20 degrees away from the plane. While these dimensions are representative of the exemplary embodiment, they are not to be limiting, as different objectives can require variations in these dimensions, the addition or subtraction of the steps and/or micro-ramps, and other changes to the geometry to tailor the resultant spray pattern to a given objective.

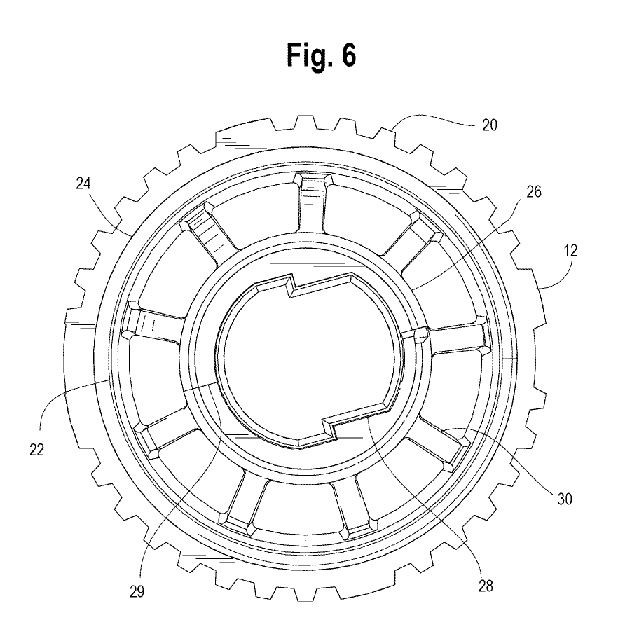

The deflector 16 is attached to the base 12 via engagement between a pair of depending prongs 46 and 48 of the neck 50 and structure surrounding the central opening of the base 12. More specifically, the base 12 includes an interior center disc 26 supported in spaced relation from the upper skirt 22 via a plurality of connecting webs 30, as depicted in FIG. 6. The central opening 28 extends through the disc 26. Barbed ends of the prongs 46 and 48 are configured to extend through the central opening 28 to form a cantilever snap fit to secure the deflector 16 relative to the base 12 with the collar 14 therebetween. Further, the central opening 28 is optionally key-shaped or otherwise asymmetric in at least one direction. When one of the prongs 48 is larger than the other of the prongs 46 in its arcuate extent, as depicted in FIG. 8, the key-shaped central opening 28 and the differently-sized prongs 46 and 48 can cooperate to ensure that the deflector 16 can only be attached to the base 12 in a single preferred orientation.

It will be understood that various changes in the details, materials, and arrangements of parts and components, which have been herein described and illustrated in order to explain the nature of the invention may be made by those skilled in the art within the principle and scope of the invention as expressed in the appended claims.

1. An irrigation spray nozzle comprising:
a nozzle body defining at least in part one or more fluid discharge flow passages for the passage of water; and
a deflector to deflect water received from the nozzle, the deflector having a plurality of depending ribs forming channels for water flow therebetween, a plurality of the ribs each having an outwardly-extending step at least partially along the length of the ribs such that a micro-ramp extends into the channels for directing a portion of the water flow.

2. The irrigation spray nozzle of claim 1, wherein the channels have a bottom defined by the deflector and the plurality of ribs are each wider on a side of the step adjacent the bottom of the channels than on an opposite side of the step from the bottom of the channels.

3. The irrigation spray nozzle of claim 1, wherein a plurality of the ribs each have more than one outwardly-extending steps at least partially along the length of the ribs such that more than one micro-ramp of each of the plurality of ribs extends into the channels for directing a portion of the water flow.

4. The irrigation spray nozzle of claim 3, wherein the channels have a bottom defined by the deflector and the plurality of ribs are each wider on a side of any one of the more than one steps adjacent the bottom of the channels than on an opposite side of the one of the steps from the bottom of the channels.

5. The irrigation spray nozzle of claim 4, wherein the plurality of ribs each have a first step and a second step, the first step being closer to the bottom of the channel than the second step, and each of the plurality of ribs having an underside, the bottom of the channels, the first steps, second steps and underside of the ribs each configured to provide for more than one discrete spray.

6. The irrigation spray nozzle of claim 5, wherein the first step provides for a first micro-ramp which directs a first segment of the spray, the second step provides for a mid-range micro-ramp which directs a mid-range spray segment extending closer from the spray nozzle as compared to the first segment, the underside of the rib provides for a close-in micro-ramp which directs a close-in spray segment extending closer from the spray nozzle as compared to the mid-range spray segment, and a second ramp including the bottom of the channel which directs a second spray segment spray extending further than the mid-range and close-in spray segments and orientated out of phase with the first segment.

7. The irrigation spray nozzle of claim 1, wherein the deflector has an upper portion with an underside with the depending ribs thereon and a lower portion with a neck depending from the underside with a plurality of flow notches disposed about its outer periphery, the flow notches being aligned with channels formed between the ribs such that water flow paths extend through the flow notches and into the channels.

8. The irrigation spray nozzle of claim 1, further comprising:
a base having a first end portion adapted for attachment to an irrigation device and a second end portion;
a first helical surface fixed relative to the base;
a second helical surface rotatable relative to the base, the first and second helical surfaces cooperating to define an arcuate flow passage adjustable in size to determine an arc of spray distribution upon relative between the first and second helical surfaces.

9. The irrigation spray nozzle of claim 8, wherein the nozzle body is a collar mounted for rotation about the second end portion of the base and includes the second helical surface and a neck of the deflector includes the first helical surface.

10. The irrigation spray nozzle of claim 9, wherein the deflector has an upper portion with an underside with the depending ribs thereon and the neck depends from the underside and has a plurality of flow notches disposed about its outer periphery, the flow notches being aligned with channels formed between the ribs such that water flow paths extend through the flow notches and into the channels.

11. An irrigation spray nozzle comprising:
a base having a longitudinal axis and at least one water passage extending through base; and
a deflector body having an upper deflector portion and a lower neck, the upper deflector portion being positioned to receive a discharge of water from the water passage and redirecting the discharge of water generally radially outward, the upper deflector portion having a plurality of radially-outward extending, depending ribs forming channels for water flow therebetween, the ribs each having a pair of sidewalls and a bottom wall, the sidewalls each at least partially defining a plurality of distinct micro-ramps for dividing the discharge of water into different sprays for irrigating different areas adjacent the irrigation spray nozzle.

12. The irrigation spray nozzle of claim 11, wherein the neck has a plurality of flow notches disposed about its outer periphery, the flow notches being aligned with the channels formed between the ribs such that a water flow path extends through the flow notches into the channels.

13. The irrigation spray nozzle of claim 11, wherein each of the plurality of ribs has a plurality of steps each projecting toward an adjacent rib a different distance.

14. The irrigation spray nozzle of claim 11, wherein one of the micro-ramps has a radially-outward portion that is inclined away from the bottom of the channel to a greater degree than another of the micro-ramps on the same side of the same one of the ribs.

15. The irrigation spray nozzle of claim 14, wherein the bottom wall of each of the plurality of ribs has a radially outward portion that is inclined away from the bottom of the channel to a greater degree than the radially-outward portion of the one of the micro-ramps.

16. The irrigation spray nozzle of claim 15, wherein each of the plurality of ribs are narrowed at a downstream end as compared to an upstream end.

17. The irrigation spray nozzle of claim 11, wherein:
the lower neck of the deflector has a deflector helical surface that is fixed relative to the base; and
a collar is mounted for rotation relative to a portion of the base, the collar having a collar helical surface configured to cooperate with the deflector helical surface to define an arcuate flow opening upstream of the upper deflector portion and adjustable in size to determine an arc of water distribution upon rotation of the collar relative to the deflector.

18. A method for forming a spray of water from an irrigation spray nozzle, the nozzle having a deflector with a plurality of radially-outward extending, depending ribs forming channels for water flow therebetween, the ribs each having a pair of sidewalls and a bottom wall, the sidewalls each having at least one step projecting laterally a first distance from the sidewall and spaced from a bottom of the channel, the method comprising:
discharging water against the deflector; and
deflecting at least some of the water generally radially outward along a plurality of flow paths disposed between adjacent pairs of the ribs and the bottom of the channels, a first of the flow paths on a side of the steps closer to the bottom wall having a first fraction of the total discharged water volume and a second of the flow paths on a side of the step opposite the bottom wall having a second fraction of the total discharged water volume, the second fraction being different than the first fraction.

19. The method of claim 18, wherein the step of deflecting the water radially outward further includes redirecting a secondary portion of the water from the second of the flow paths to thereby having a primary and secondary portion of the water, the secondary portion of the water having a throw different than that of the primary portion.

20. The method of claim 19, wherein the step of discharging water and against the deflector further includes the step of dividing the water into discrete flows upstream of the deflector and directing each of the discrete flows into an associated one of the channels.

21. The method of claim 20, further including the step of deflecting a portion of the water generally radially outward along a plurality of close-in flow paths, each of the close-in flow paths being disposed on an underside of the ribs, the water discharging along the close-in flow path having a throw less than the first of the flow paths.

22. The method of claim 18, further including a step of adjusting the arcuate extent of a discharge opening prior to the step of discharging water against the deflector.
